(19) United States
(12) Patent Application Publication
(10) Pub. No.: US 2019/0112867 A1
(43) Pub. Date: Apr. 18, 2019

(54) RAILWAY CAR HATCH COVER HYDROPHOBIC COATING ON VENTS

(71) Applicant: Amsted Rail Company, Inc., Chicago, IL (US)

(72) Inventor: Richard Warren, Columbia, IL (US)

(21) Appl. No.: 15/783,326

(22) Filed: Oct. 13, 2017

(51) Int. Cl. E06B 7/02; E06B 7/16; B61D 49/00

(52) U.S. Cl. CPC E06B 7/02; B61D 7/00; B61D 49/00; E06B 7/16

(57) ABSTRACT

A railway car hatch cover assembly is provided comprising an outer hatch cover, and a gasket retainer. A venting gasket is provided comprised of mesh venting material, and a hydrophobic coating is applied to the mesh venting material. The venting gasket forms a seal with the outer hatch cover and the hatch ring coaming. The hydrophobic coating is usually applied to an outer surface of the mesh venting material. The mesh venting material allows the passage of air therethrough, while providing a barrier to the passage of dirt or similar debris.

### BACKGROUND OF THE INVENTION

The invention relates generally to railway car hatch covers, and more particularly to venting of railway car hatch covers.

This invention is applicable to railway car hatch covers. On covered hopper railway cars, each car has a series of hatches on top of the car that allow the railway cars to be filled from the top with various commodities, such as plastic pellets, flour, grain food products, and the like. The hatches also allow access into the car for maintenance and an opening for venting purposes. After the railway car is loaded, a hatch cover which includes a seal assembly is secured over each hatch to prevent outside substances from contaminating the goods in the car, and also to prevent spillage and secure the goods or substance inside the car for transportation.

To facilitate unloading of the car, vented covers are incorporated to allow unloading via pneumatic conveying means. The vented covers allow atmospheric makeup air to enter the car through the hatch ring coaming during unloading to equalize pressure. The vented covers include venting materials, typically meshes, to block large objects and allow for the air exchange.

While vented covers have benefits to unloading, it also allows for contamination. The venting material allows a path into the sealed car for moisture due to rain, snow, etc.

The present invention relates to the application of a hydrophobic coating to the venting material thus no longer allowing water to pass through the opening while still allowing air to flow unencumbered. The hydrophobic coating used can be found on materials provided by Outerwears or equivalent materials with similar hydrophobic properties.

### SUMMARY OF THE INVENTION

The present invention relates to a coating applied to the railway car hatch cover venting materials. One embodiment of the invention includes a polymer mesh with a hydrophobic coating applied. The mesh material allows air to flow into the sealed railway car hatch ring coaming while the hydrophobic coating hinders the passage of water.

### BRIEF DESCRIPTION OF THE DRAWINGS

In the drawings,

FIG. 1 is an exploded view of a hatch cover assembly in accordance with an embodiment of the present invention;

FIG. 2 is a sectional view of the hatch cover assembly shown in FIG. 1, and

FIG. 3 is a section view of the venting material used in the hatch cover assembly shown in FIG. 1.

### DETAILED DESCRIPTION

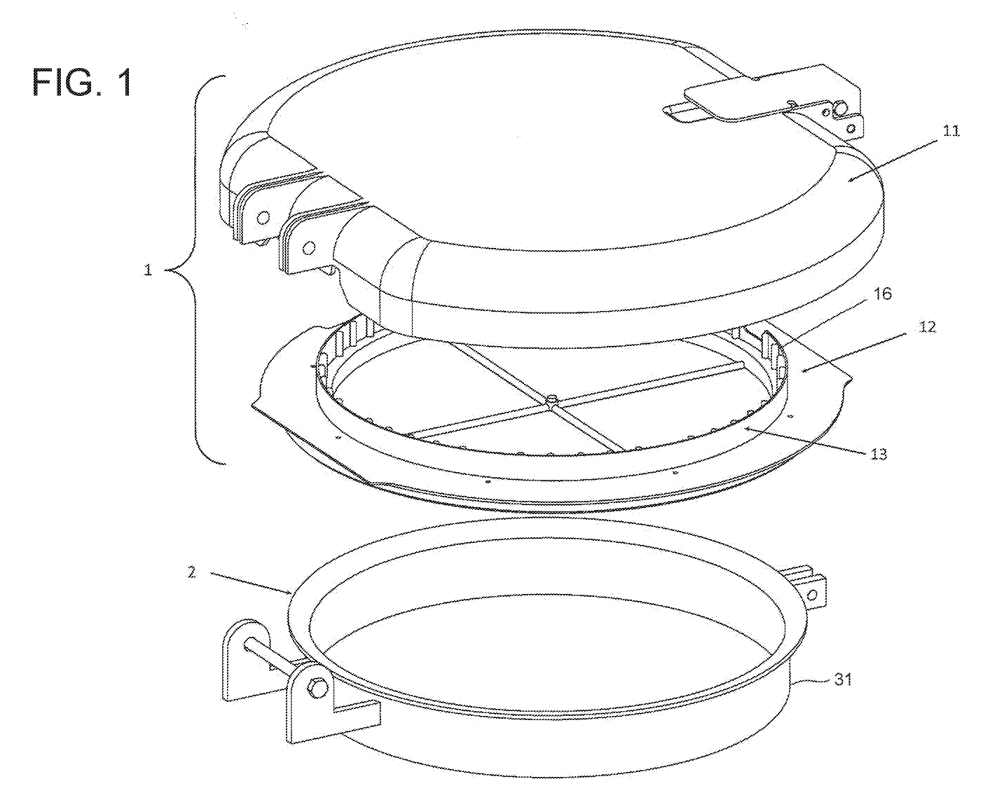

FIG. 1 illustrates an exploded view of a hatch cover assembly 1. Outer cover 11 of hatch cover assembly 1 shields railcar hatch ring coaming 31 having top edge 2 and thusly prohibits debris from entering the railcar. Gasket retainer 12 secures venting gasket 13 and allows an upper edge 16 of venting gasket to form a seal with the underside of outer cover 11 of hatch cover assembly 1. Venting gasket 13 is usually comprised of a mesh material.

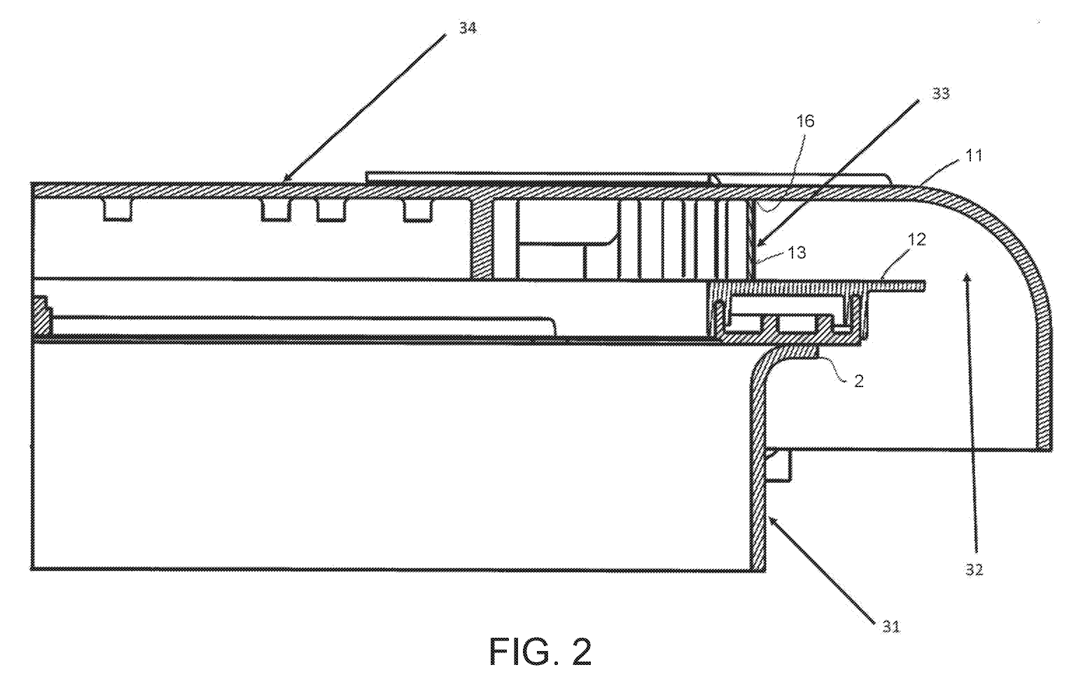

FIG. 2 further illustrates a section view of the hatch cover assembly 1. Space 32 comprises an opening in which atmospheric makeup air is allowed to enter the railcar body hatch ring coaming 31 during unloading of the railcar's lading via pneumatic conveying means. The mesh venting material 33 of which venting gasket 13 is comprised forms a seal with the underside of hatch cover assembly 34, but allows air flow through space 32 of the hatch cover assembly 34 while blocking entry to usual debris such as dirt particles, leaves, etc.

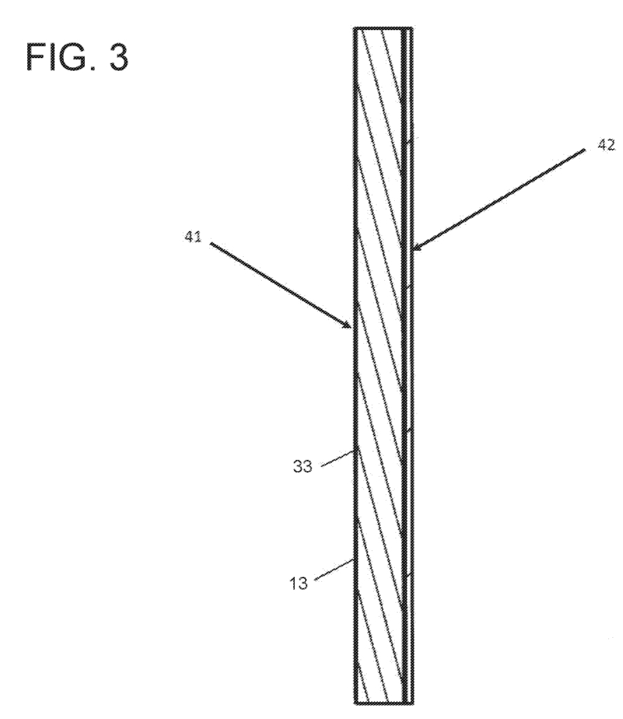

FIG. 3 illustrates a section of the mesh venting material 33 of venting gasket 13. Mesh substrate 41 provides a base for venting gasket 13. A hydrophobic coating 42 is applied to an outer surface of mesh substrate 41 and allows airflow through mesh substrate 41 while blocking water from penetrating the sealed railway hatch cover assembly 1 and entering the railcar.

What is claimed is:

1. A railway car hatch cover assembly comprising
an outer hatch cover,
a gasket retainer,
a venting gasket comprised of mesh venting material,
and a hydrophobic coating applied to the mesh venting material.

2. The railway hatch cover assembly of claim 1 wherein the venting gasket forms a seal with the outer hatch cover and the hatch ring coaming.

3. The railway hatch cover assembly of claim 2 wherein the hydrophobic coating is applied to an outer surface of the mesh venting material.

4. The railway hatch cover assembly of claim 3 wherein the mesh venting material allows the passage of air therethrough.

5. The railway hatch cover assembly of claim 1 wherein the venting gasket forms a seal with the outer hatch cover and the hatch ring coaming and wherein the hydrophobic coating is applied to an outer surface of the mesh venting material.

6. A railway car hatch cover assembly comprising
an outer hatch cover,
a gasket retainer,
a venting gasket comprised of mesh venting material,
and a hydrophobic coating applied to the mesh venting material
and wherein
the venting gasket forms a seal with the outer hatch cover and hatch ring coaming and the hydrophobic coating is applied to an outer surface of the mesh venting material.

7. The railway hatch cover assembly of claim 6 wherein
the mesh venting material allows the passage of air therethrough.
